(19) United States
(12) Patent Application Publication
(10) Pub. No.: US 2020/0025238 A1
(43) Pub. Date: Jan. 23, 2020

(54) CONNECTING ROD AND A METHOD OF MANUFACTURING THE CONNECTING ROD

(71) Applicant: GM Global Technology Operations LLC, Detroit, MI (US)

(72) Inventors: Anthony M. Coppola, Rochester Hills, MI (US); Hamid G. Kia, Bloomfield Hills, MI (US); Peter P. Andruskiewicz, IV, Ann Arbor, MI (US); Paul M. Najt, Bloomfield Hills, MI (US)

(73) Assignee: GM Global Technology Operations LLC, Detroit, MI (US)

(21) Appl. No.: 16/037,663

(22) Filed: Jul. 17, 2018

(51) Int. Cl. F16C 7/02; B29C 70/86; B29C 70/38; F16C 9/04

(52) U.S. Cl. CPC F16C 7/023; B29C 70/865; B29L 2031/06; F16C 9/04; B29C 70/382

(57) ABSTRACT

A connecting rod includes a shank formed of a composite. The connecting rod also includes a first end portion coupled to the shank and a second end portion coupled to the shank. The first end portion has an annular shaped portion, and the second end portion has an annular shaped portion. The shank defines a channel coupled to the first and second end portions.

A method of manufacturing a connecting rod includes placing a plurality of fibers in a predetermined arrangement, and adding a resin to the plurality of fibers to connect the fibers together and form a composite of at least a shank. The method also includes disposing a component inside the shank, and the component is utilized to define a channel in the shank. The method further includes coupling a first end portion to the shank, and coupling a second end portion to the shank.

The present disclosure relates to composite connecting rods for use in an internal combustion engine. Some internal combustion engines include a crankshaft, a plurality of pistons, and a plurality of connecting rods. Each of the connecting rods connects one of the pistons with the crankshaft.

### SUMMARY

The present disclosure provides a connecting rod that includes a shank formed of a composite. The connecting rod also includes a first end portion coupled to the shank and a second end portion coupled to the shank. The first end portion has an annular shaped portion, and the second end portion has an annular shaped portion. The shank defines a channel coupled to the first and second end portions.

The connecting rod optionally includes one or more of the following:

A) a component disposed in the shank to form the channel;

B) the component is further defined as a sacrificial component;

C) the sacrificial component is ignited to cause deflagration of the sacrificial component, thereby forming the channel in the shank;

D) the sacrificial component is melted to remove the sacrificial component from the shank, thereby forming the channel in the shank;

E) the component is further defined as a tube;

F) the first end portion includes a first inner surface that defines a boundary of a first cavity;

G) the first end portion includes a first wall that defines a boundary of a first passageway, and the first passageway connects with the first cavity and the channel;

H) the second end portion includes a second inner surface that defines a boundary of a second cavity;

I) the second end portion includes a second wall that defines a boundary of a second passageway, and the second passageway connects with the second cavity and the channel;

J) at least one of the first and second walls includes a tapered portion that changes a size of at least one of the first and second passageways respectively;

K) the tube is disposed in the first and second end portions and the shank; L) the tube includes a first end and a second end, with the first end of the tube disposed in the first end portion and the second end of the tube disposed in the second end portion;

M) at least one of the first and second ends of the tube taper along the tapered portion of the at least one of the first and second walls respectively;

N) a first bearing secured to the first end portion and a second bearing secured to the second end portion;

O) the first end portion defines a first passageway that opens to the first bearing;

P) the second end portion defines a second passageway that opens to the second bearing;

Q) the first and second passageways and the channel of the shank cooperate with each other to define a passage to the first and second bearings;

R) the first end portion and the second end portion are each formed of a metal;

S) the composite is further defined as a polymer composite that is different from the metal of the first and second end portions;

T) the shank extends along a shank axis, and the composite of the shank is further defined as a fiber-reinforced composite that includes a matrix and a plurality of fibers embedded in the matrix;

U) the plurality of fibers includes shank fibers disposed in the shank, and at least one of the shank fibers is elongated along the shank axis;

V) the shank, the first end portion and the second end portion are each formed of the composite;

W) the at least one of the shank fibers is oriented at a shank fiber angle relative to the shank axis, and the shank fiber angle is between zero degrees and twenty-five degrees;

X) the plurality of fibers includes first-end fibers, and the first-end fibers extend annularly within the first end portion;

Y) the first end portion includes a first inner surface that defines a boundary of a first cavity, and the first inner surface has an annular shape;

Z) the first inner surface has a first circumference, and at least one of the first-end fibers entirely and continuously surrounds an entirety of the first circumference of the first inner surface;

AA) a first bearing disposed in the first cavity;

BB) the plurality of fibers includes second-end fibers, and the second-end fibers extend annularly within the second end portion;

CC) the second end portion includes a second inner surface that defines a boundary of a second cavity, and the second inner surface has an annular shape;

DD) the second inner surface has a second circumference, and at least one of the second-end fibers entirely and continuously surrounds an entirety of the second circumference of the second inner surface;

EE) the second circumference is greater than the first circumference; and

FF) a second bearing disposed in the second cavity.

The present disclosure also provides a method of manufacturing a connecting rod that includes placing a plurality of fibers in a predetermined arrangement, and adding a resin to the plurality of fibers to connect the fibers together and form a composite of at least a shank. The method also includes disposing a component inside the shank, and the component is utilized to define a channel in the shank. The method further includes coupling a first end portion to the shank, and coupling a second end portion to the shank.

The method optionally includes one or more of the following:

A) the first end portion and the second end portion are separate pieces from the shank;

B) coupling the first end portion to the shank further includes inserting a protrusion of the first end portion into a first recess of the shank;

C) coupling the second end portion to the shank further includes inserting a protrusion of the second end portion into a second recess of the shank;

D) the shank, the first end portion and the second end portion are each formed together of the composite;

E) coupling the first end portion to the shank further includes placing the fibers and adding the resin to the fibers to connect the fibers together and form the shank, the first end portion as a one-piece structure;

F) coupling the second end portion to the shank further includes placing the fibers and adding the resin to the fibers to connect the fibers together and form the shank, the second end portion as one-piece structure;

G) the component is further defined as a sacrificial component;

H) removing the sacrificial component from the shank, thereby forming the channel in the shank;

I) the component is further defined as a tube; and

J) forming the composite of the shank around the tube, and the tube remains inside the shank to define the channel in the shank.

The detailed description and the drawings or FIGS. are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic isometric of part of an internal combustion engine that includes at least one connecting rod.

FIG. 2 is a schematic front view of a connecting rod defining a channel as shown via the evenly spaced dashes, and this connecting rod may be utilized in the internal combustion engine of FIG. 1.

FIG. 3 is a schematic cross-sectional view of the connecting rod of FIG. 2.

FIG. 4 is a schematic illustration of a component disposed in a shank to define a channel in the shank.

FIG. 5 is a schematic fragmentary cross-sectional view of a first end portion or a second end portion including a tapered portion.

FIG. 6 is a schematic front view of a connecting rod defining a plurality of channels as shown via the evenly spaced dashes, and this connecting rod may be utilized in the internal combustion engine of FIG. 1.

FIG. 7 is a schematic cross-sectional view of the connecting rod, taken along section line 7-7 of FIG. 6.

FIG. 8 is a schematic cross-sectional view of the connecting rod, taken along section line 8-8 of FIG. 6.

FIG. 9 is a schematic front view of a connecting rod defining a channel as shown via the evenly spaced dashes, and this connecting rod may be utilized in the internal combustion engine of FIG. 1.

FIG. 10 is a schematic cross-sectional view of the connecting rod, taken along section line 10-10 of FIG. 9.

FIG. 11 is a schematic cross-sectional view of the connecting rod, taken along section line 11-11 of FIG. 9.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

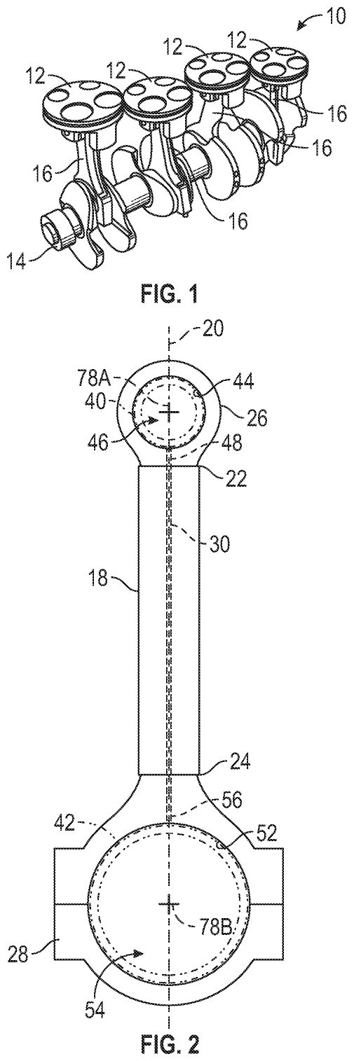

Referring to the FIGS., wherein like numerals indicate like or corresponding parts throughout the several views, FIG. 1 schematically illustrates part of an internal combustion engine 10. The internal combustion engine 10 may include a plurality of pistons 12, a crankshaft 14, and a plurality of connecting rods 16. Generally, each of the connecting rods 16 connects one of the pistons 12 to the crankshaft 14. The below discussion generally refers to one connecting rod 16, but it is to be appreciated that any/all of the connecting rods 16 of the internal combustion engine 10 may be configured as discussed below. In addition, the methods described in this disclosure may also be used to make other linkages such as steering linkages, suspension linkages, shift linkages, bike components, etc.

The connecting rod 16 may be utilized in vehicle applications, or alternatively, the connecting rod 16 may be utilized in non-vehicle applications. Non-limiting examples of vehicle applications include a motor vehicle, marine vehicle, aerospace vehicle, robot, farm equipment, bicycles or other movable platform. Non-limiting examples of non-vehicle applications include a stationary power plant, machines, farm equipment, etc.

Referring to FIGS. 2, 3, 6 and 9, the connecting rod 16 includes a shank 18 formed of a composite. Hence, a plurality of materials is utilized to form the shank 18. The materials that form the shank 18 may be a resin that is disposed inside a mold or overwrapped, etc. as discussed further below. Non-limiting examples of the material may include polymers, fibers, combinations thereof, some of which are discussed further below.

The shank 18 may extend along a shank axis 20. Furthermore, the shank 18 may include a first shank end 22 and a second shank end 24 opposite the first shank end 22. Generally, the first and second shank ends 22, 24 are spaced apart from each other along the shank axis 20.

Continuing with FIGS. 2, 3, 6 and 9, the connecting rod 16 includes a first end portion 26 coupled to the shank 18 and a second end portion 28 coupled to the shank 18. The first end portion 26 may be directly coupled to the first shank end 22 to enhance the structural integrity of the connecting rod 16. Furthermore, the second end portion 28 may be directly coupled to the second shank end 24 to enhance the structural integrity of the connecting rod 16. As best shown in FIGS. 2, 6 and 9, the first end portion 26 has an annular shaped portion, and the second end portion 28 has an annular shaped portion.

As best shown in FIGS. 2, 3, 6 and 9, the shank 18 defines a channel 30 coupled to the first and second end portions 26, 28. It is to be appreciated that more than one channel 30 may be formed within the shank 18. The channel(s) 30 formed in the connecting rod 16 may be produced via a vascular manufacturing process or system, which is detailed below. The one or more channels 30 in the connecting rod 16 described herein may be utilized to guide a fluid, such as a liquid, to lubricate and/or cool at least part of the connecting rod 16. Additionally, cooling at least part of the connecting rod 16 may improve durability and longevity of the connecting rod 16.

Generally, the fluid is fed into the connecting rod 16 via the crankshaft 14. Specifically, the crankshaft 14 may define at least one hole, in which the fluid, the fluid being pressurized through the hole, is delivered to one of the first and second end portions 26, 28. For example, the second end portion 28 may be connected to the crankshaft 14, and in this configuration, the fluid is delivered to the connecting rod 16 through the second end portion 28. It is to be appreciated that the crankshaft 14 may define a plurality of holes to deliver the fluid to the connecting rod 16. Delivery of the fluid into/through the connecting rod 16 is discussed further below.

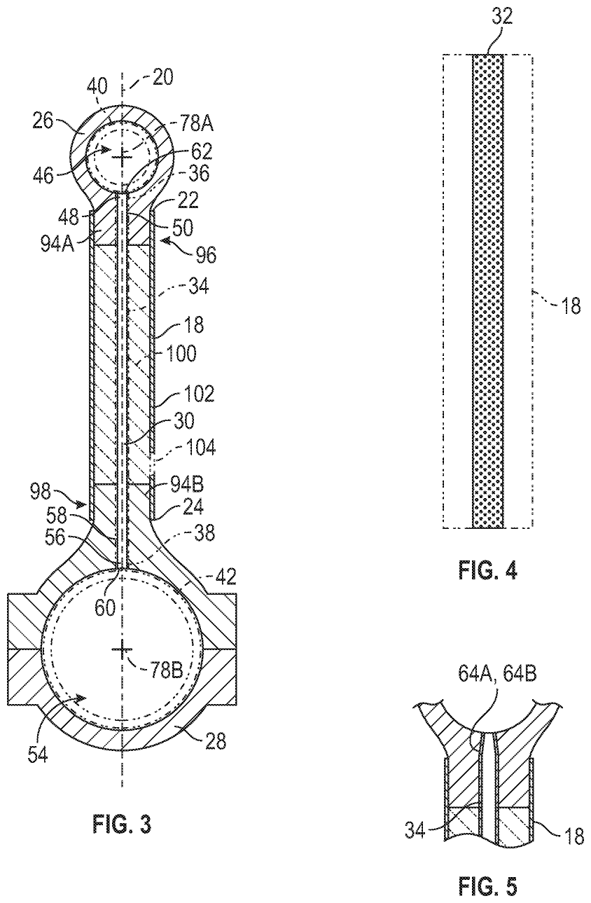

Referring to FIG. 4, the connecting rod 16 includes a component 32 disposed in the shank 18 to form the channel 30. The component 32 may be configured in different configurations to form the channel 30, some of which are discussed below. For example, if the shank 18 is formed utilizing the mold, once the materials cure, harden, etc., depending on the configuration of the component 32, the component 32 may need to be removed from the shank 18 to form the one channel 30. Alternatively, if the component 32 is a tube 34 (shown in phantom lines in FIGS. 3, 7, 8, 10 and 11), nothing else is needed to form the channel 30 because the tube 34 already has the channel 30 therein.

As mentioned above, depending on the configuration of the component 32, the component 32 may be removed to form the channel 30. In this configuration, the component 32 is further defined as a sacrificial component. Hence, if the component 32 is removed from the shank 18 to form the channel 30, then, in certain embodiments, the component 32 is further defined as the sacrificial component. Any suitable sacrificial component may be utilized, and non-limiting examples are discussed below. Furthermore, the sacrificial component may be ignited or burned, vaporized, melted, decomposed, dissolved, manually extracted from the channel 30, etc., as non-limiting examples, and some of these methods are discussed further below.

The sacrificial component may be ignited to cause deflagration of the sacrificial component, thereby forming the channel 30 in the shank 18. For example, a portion of the sacrificial component may be ignited to remove the sacrificial component. It is contemplated that the sacrificial component may be self-oxidizing to burn in a small diameter along long channels 30, and thus the sacrificial component may include a combustible material. The sacrificial component may also be resistant to molding pressures. Further, the sacrificial component is shelf stable and stable during manufacturing (e.g., the flash point is greater than the manufacturing or processing temperature). The term “flash point” means the lowest temperature at which vapors of the combustible material will ignite, when given an ignition source. The sacrificial component is molded directly or indirectly to the shank 18 at a processing temperature that is less than the flash point of the combustible material to avoid deflagration during the manufacturing process. The term “processing temperature” means a temperature required to perform a manufacturing operation, such as molding or casting. For example, the processing temperature may be the melting temperature of the material forming the shank 18 (e.g., the melting temperature of the polymeric resin forming the shank 18). The sacrificial component is wholly or partly made of the combustible material. To achieve the desired properties mentioned above, the combustible material may be black powder (i.e., a mixture of sulfur, charcoal, and potassium nitrate). To achieve the desired properties mentioned above, the combustible material may alternatively or additionally be pentaerythritol tetranitrate, combustible metals, combustible oxides, thermites, nitrocellulose, pyrocellulose, flash powders, and/or smokeless powder. Non-combustible materials could be added to the sacrificial component to tune speed and heat generation. To tune speed and heat generation, suitable non-combustible materials for the sacrificial component include, but are not limited to, glass beads, glass bubbles, and/or polymer particles.

In other embodiments, the sacrificial component may be melted to remove the sacrificial component from the shank 18, thereby forming the channel 30 in the shank 18. For example, the sacrificial component may be heated to melt the sacrificial component. Therefore, the sacrificial component may include a meltable material. The sacrificial component is molded directly to the shank 18 at a processing temperature that is less than a melting point of the meltable material. The term “melting point” means the lowest temperature at which the meltable material will melt, when given a heat source. The sacrificial component may also be resistant to molding pressures. Further, the sacrificial component is shelf stable and stable during manufacturing (i.e., the flash point is greater than the manufacturing or processing temperature). Non-limiting examples of the meltable material may include one or more of polymer(s), glass fiber(s), metal(s), composite(s), etc.

If the component 32 is meltable or vaporizing materials are used in this process, the resin may be wholly or partly made of thermosets, such as epoxies, phenolic, polyurethanes, polyesters, bis-maleimides (BMIs), polyimides, benzoxazines. Alternatively or additionally, the component 32 may be wholly or partly made of depolymerizable or degradable materials, such as polymers, metals, and ceramics. “Depolymerizable or degradable materials” are polymeric materials that may undergo depolymerization (or that may degrade) to revert the materials to their monomers at relatively low temperatures such as room temperature. If depolymerizable or degradable materials are used in this process, the resin may be wholly or partly made of thermoplastics, such as polyamides, polyethylenes, and/or polypropylenes. The component 32 may be wholly or partly made of dissolvable materials. “Dissolvable materials” are salts, waxes, or plastic that may dissolve when exposed to a solution, such as an aqueous solution.

Optionally, the sacrificial component may include a protective shell that surrounds the material(s) that are ignited and/or melted, to contain the burning and/or melting, which may be non-soluble material in combustible resin (e.g., epoxy, polyurethane, polyester, among others) in order to be shelf stable and stable during manufacturing. Also, this protective material is impermeable to the resin and moisture. The protective material has sufficient structural stability to be integrated into a fiber textiling and preforming process. The protective material has sufficient strength and flexibility to survive the fiber preform process. To achieve the desirable properties mentioned above, the protective material may include, for example, braided fibrous material, such as glass fiber, aramid fiber, carbon fiber, and/or natural fiber, infused with an infusion material such as a polymer or wax, oil, a combination thereof or similar material. To achieve the desirable properties mentioned above, the infused polymer may be, for example, polyimide, polytetrafluoroethylene (PTFE), high-density polyethylene (HDPE), polyphenylene sulfide (PPS), polyphthalamide (PPA), polyamides (PA), polypropylene, nitrocellulose, phenolic, polyester, epoxy, polylactic acid, bismaleimides, silicone, acrylonitrile butadiene styrene, polyethylene, polycarbonate, elastomers, polyurethane, polyvinylidene chloride (PVDC), polyvinyl chloride (PVC), polystyrene (PS) a combination thereof, or any other suitable plastic. Suitable elastomers include, but are not limited to, natural polyisoprene, synthetic polyisoprene, polybutadiene (BR), chloroprene rubber (CR), butyl rubber, styrene-butadiene rubber, nitrile rubber, ethylene propylene rubber, epichlorohydrin rubber (ECO), polyacrylic rubber, fluorosilicone rubber, perfluoroelastomers, polyether block amides, chlorosulfonated polyethylene, ethylene-vinyl acetate, shellac resin, nitrocellulose lacquer, epoxy resin, alkyd, polyurethane, etc.

If the component 32 is further defined as the tube 34 (shown in phantom lines in FIGS. 3 and 5), as discussed further below, nothing else is needed to form the channel(s) 30 because the tube 34 already has the channel 30 therein. As such, when utilizing the tube 34, the tube 34 remains secured to the shank 18 and/or the first and second end portions 26, 28. The tube 34 may be a rigid tube or a flexible tube, with the flexible tube being more pliable than the rigid tube.

As best shown in FIG. 3, the tube 34 may include a first end 36 and a second end 38. In certain embodiments, the first end 36 of the tube 34 may be disposed in the first end portion 26 and the second end 38 of the tube 34 may be disposed in the second end portion 28. Hence, in certain embodiments, the tube 34 may be disposed in the first and second end portions 26, 28 and the shank 18.

Referring to FIGS. 2, 6 and 9, the connecting rod 16 may include a first bearing 40 and a second bearing 42 (shown schematically in phantom lines in FIGS. 2, 6 and 9). In this configuration, the channel 30 may be utilized to deliver the fluid to the first and second bearings 40, 42 to lubricate and/or cool the first and second bearings 40, 42. Hence, the first and second bearings 40, 42 may be lubricated via a lubricant disposed in the channel 30. In certain embodiments, the first bearing 40 may be secured to the first end portion 26 and the second bearing 42 may be secured to the second end portion 28.

Referring to FIGS. 2, 3, 6 and 9, the first end portion 26 may include a first inner surface 44 that defines a boundary of a first cavity 46. Generally, the first bearing 40 may be disposed in the first cavity 46. More specifically, in certain embodiments, the first bearing 40 is secured to the first inner surface 44 within the first cavity 46. As best shown in FIGS. 2, 6 and 9, in certain embodiments, the first inner surface 44 has an annular shape.

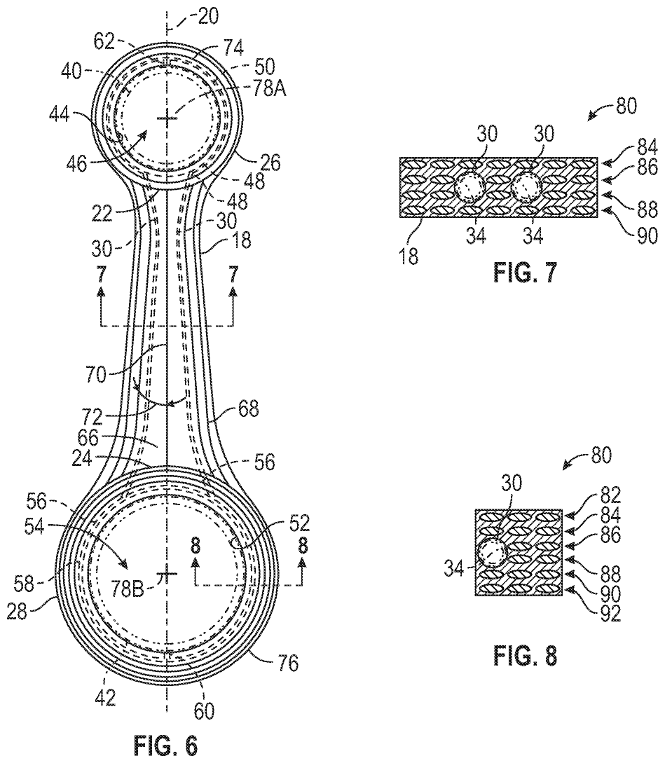

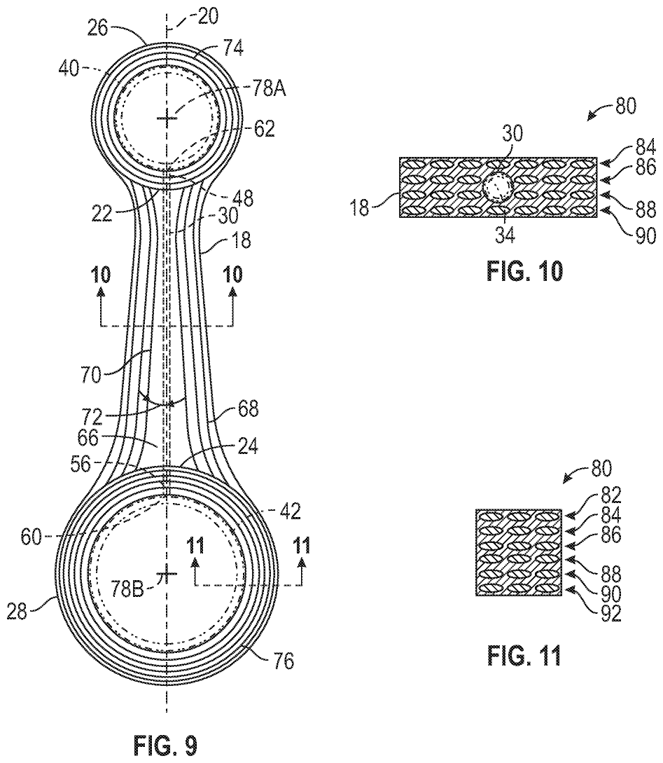

Additionally, continuing with FIGS. 2, 3, 6 and 9, the first end portion 26 may define a first passageway 48 that opens to the first bearing 40. More specifically, the first end portion 26 may include a first wall 50 that defines a boundary of the first passageway 48. The first passageway 48 connects with the first cavity 46 and the channel 30. As such, the fluid may be disposed in the first passageway 48, and delivered to the first bearing 40. The first passageway 48 may deliver the fluid to the first bearing 40 to lubricate and/or cool the first bearing 40. The first passageway 48 is also in fluid communication with the channel 30 to deliver the fluid. In certain configurations, the first passageway 48 may surround the first cavity 46 (see FIG. 6), and in other configurations, the first passageway 48 does not annularly surround the first cavity 46 (see FIGS. 3 and 9).

Furthermore, continuing with FIGS. 2, 3, 6 and 9, the second end portion 28 may include a second inner surface 52 that defines a boundary of a second cavity 54. Generally, the second bearing 42 may be disposed in the second cavity 54. More specifically, in certain embodiments, the second bearing 42 is secured to the second inner surface 52 within the second cavity 54. As best shown in FIGS. 2, 6 and 9, in certain embodiments, the second inner surface 52 has an annular shape.

Continuing with FIGS. 2, 3, 6 and 9, the second end portion 28 may define a second passageway 56 that opens to the second bearing 42. More specifically, the second end portion 28 may include a second wall 58 that defines a boundary of the second passageway 56. The second passageway 56 connects with the second cavity 54 and the channel 30. As such, the fluid may be disposed in the second passageway 56, and delivered to the second bearing 42. The second passageway 56 may deliver the fluid to the second bearing 42 to lubricate and/or cool the second bearing 42. The second passageway 56 is also in fluid communication with the channel 30 to deliver the fluid. In certain configurations, the second passageway 56 may surround the second cavity 54 (see FIG. 6), and in other configurations, the second passageway 56 does not annularly surround the second cavity 54 (see FIGS. 3 and 9).

The first and second passageways 48, 56 of the first and second end portions 26, 28 and the channel 30 of the shank 18 cooperate with each other to define a passage to the first and second bearings 40, 42. Said differently, the first and second passageways 48, 56 and the channel 30 are in fluid communication with each other to define the passage. Therefore, the fluid may be delivered to the first and second bearings 40, 42 via the passage to lubricate and/or cool the bearings 40, 42.

As mentioned above, generally, the crankshaft 14 is responsible for delivering the pressurized fluid to the connecting rod 16, and more specifically, deliver the fluid to the first and second bearings 40, 42 of the connecting rod 16. As also mentioned above, the fluid is pressurized when exiting the crankshaft 14, and thus, pushes the fluid into/through the connecting rod 16. If the crankshaft 14 is connected to the second end portion 28, then the hole of the crankshaft 14 is in fluid communication with the second cavity and then the second bearing 42. One of the first and second end portions 26, 28 may define at least one inlet 60 in fluid communication with the passage and the other one of the first and second end portions 26, 28 may define at least one outlet 62 in fluid communication with the passage. The inlet 60 receives the fluid from the crankshaft 14 after passing one of the first and second bearings 40, 42. For example, the second end portion 28 may define the inlet 60 in fluid communication with the second passageway 56, and the first end portion 26 may define the outlet 62 in fluid communication with the first passageway 48. Therefore, for example, the fluid may enter the second bearing 42 via the second cavity 54 after exiting the hole of the crankshaft 14, then the fluid is delivered into the inlet 60, through the passage, then out of the outlet 62 to the first bearing 40. If the second end portion 28 defines the outlet 62 and the first end portion 26 defines the inlet 60, then the fluid may enter the first bearing 40 via the first cavity 46 after exiting the hole of the crankshaft 14, then the fluid is delivered into the inlet 60, through the passage, then out of the outlet 62 to the second bearing 42. It is to be appreciated that a plurality of inlets 60 and/or a plurality of outlets 62 may be used.

Optionally, referring to FIG. 5, the first end portion 26 may include a tapered portion 64A, and/or the second end portion 28 may include a tapered portion 64B. The tapered portion 64A, 64B of the first and/or second end portions 26, 28 may assist in sealing with the tube 34. Hence, the tube 34 may be slightly larger than the tapered portion 64A, 64B to provide the desired sealing between the walls 50, 58 and the tube 34. More specifically, at least one of the first and second walls 50, 58 may include the tapered portion 64A, 64B that changes a size of at least one of the first and second passageways 48, 56 respectively. Therefore, the first wall 50 may include the tapered portion 64A or the second wall 58 may include the tapered portion 64B, or both of the first and second walls 50, 58 may include the tapered portion 64A, 64B. Additionally, in certain embodiments, at least one of the first and second ends 36, 38 of the tube 34 taper along the tapered portion 64A, 64B of the at least one of the first and second walls 50, 58 respectively. Therefore, depending on which of the walls 50, 58 include the tapered portion 64A, 64B, the first end 36 of the tube 34 may taper or the second end 38 of the tube 34 may taper or both of the ends 36, 38 of the tube 34 may taper. Furthermore, optionally, an adhesive may be used to secure and/or seal the tube 34 to the first and second walls 50, 58, and more specifically, to secure and/or seal the tube 34 to the taper portion 64A, 64B of the first and/or second walls 50, 58.

The connecting rod 16 may be formed of various materials. More specifically, the shank 18 and the first and second end portions 26, 28 may be formed of various materials. In certain embodiments, the first and second end portions 26, 28 are formed of a first material, and the shank 18 is formed of a second material different from the first material. For example, the first end portion 26 and the second end portion 28 may each be formed of a metal, i.e., the first material. Furthermore, the second material may be the composite. More specifically, the composite may be further defined as a polymer composite, i.e., the second material, that is different from the metal of the first and second end portions 26, 28. FIGS. 2 and 3 are schematic illustrative examples of the first and second end portions 26, 28 being formed of a different material from the shank 18. By utilizing two different types of materials, i.e., the first and second end portions 26, 28 formed of metal and the shank 18 formed of the composite, the mass of the connecting rod 16 may be reduced while maximizing the stiffness of the connecting rod 16. Additionally, by reducing the mass of the connecting rod 16, fuel economy may be improved.

In other embodiments, the shank 18, the first end portion 26 and the second end portion 28 are each formed of the composite. In other words, the shank 18, the first end portion 26 and the second end portion 28 are each formed of the same composite material. In this configuration, the composite may be further defined as the polymer composite. FIGS. 6 and 9 are schematic illustrative examples of the first and second end portions 26, 28 and the shank 18 formed of the same composite material.

Referring to FIGS. 6 and 9, the composite of the shank 18 may be further defined as a fiber-reinforced composite that includes a matrix 66 and a plurality of fibers 68 embedded in the matrix 66. In other words, the fiber-reinforced composite may include the matrix 66 and the plurality of fibers 68 embedded in the matrix 66. In certain embodiments, the shank 18, the first end portion 26 and the second end portion 28 are each formed of the fiber-reinforced composite that includes the matrix 66 and the plurality of fibers 68 embedded in the matrix 66.

The matrix 66 includes a resin. The resin may be wholly or partly made of thermosets, epoxies, phenolic, polyurethanes, polyesters, bis-maleimides (BMIs), polyimides, benzoxazines, thermoplastics, polyamides, polyethylene, polypropylene, ceramics, metals, or a combination thereof. The fibers 68 may be wholly or partly made of carbon, basalt, glass, or polymeric materials such as aramids, and ultra-high-molecular-weight polyethylene (UHMPE), or combinations thereof.

Continuing with FIGS. 6 and 9, the plurality of fibers 68 may include shank fibers 70 disposed in the shank 18. At least one of the shank fibers 70 may be elongated along the shank axis 20. The at least one of the shank fibers 70 is elongated along the shank axis 20 to optimally resist stresses experienced by the connecting rod 16. In certain embodiments, most of the shank fibers 70 may be elongated along the shank axis 20 to optimally resist stresses experienced by the connecting rod 16. Accordingly, the shank fibers 70 may be referred to as axial fibers 68.

Continuing with FIGS. 6 and 9, the at least one of the shank fibers 70 may be oriented at a shank fiber angle 72 relative to the shank axis 20. In certain embodiments, the shank fiber angle 72 may be between zero degrees and twenty-five degrees. The shank fiber angle 72 may be between zero degrees and twenty-five degrees to optimally resist stresses experienced by the connecting rod 16. The polymer composite discussed above, may be further defined as the fiber-reinforced composite as discussed above.

Furthermore, with reference to FIGS. 6 and 9, the plurality of fibers 68 may include first-end fibers 74, and the first-end fibers 74 extend annularly within the first end portion 26 of the connecting rod 16. For this reason, the first-end fibers 74 may be referred to as the first annular fibers 68. The first inner surface 44 has a first circumference, and at least one of the first-end fibers 74 entirely and continuously surrounds an entirety of the first circumference of the first inner surface 44. The at least one of the first-end fibers 74 entirely and continuously surrounds an entirety of the first circumference of the first inner surface 44 to optimally resist stresses experienced by the connecting rod 16. In certain embodiments, most of the first-end fibers 74 may entirely and continuously surround an entirety of the first circumference of the first inner surface 44 to optimally resist stresses experienced by the connecting rod 16.

Additionally, with reference to FIGS. 6 and 9, the plurality of fibers 68 may include second-end fibers 76, and the second-end fibers 76 extend annularly within the second end portion 28 of the connecting rod 16. For this reason, the second-end fibers 76 may also be referred to as second annular fibers 68. The second inner surface 52 has a second circumference, and at least one of the second-end fibers 76 entirely and continuously surrounds an entirety of the second circumference of the second inner surface 52. The at least one of the second-end fibers 76 entirely and continuously surrounds an entirety of the second circumference of the second inner surface 52 to optimally resist stresses experienced by the connecting rod 16. In certain embodiments, most of the second-end fibers 76 entirely and continuously surround an entirety of the second circumference of the second inner surface 52 to optimally resist stresses experienced by the connecting rod 16.

As best shown in FIGS. 2, 3, 6 and 9, the second cavity 54 is larger than the first cavity 46 because the first end portion 26 connects to the piston 12, and the second end portion 28 connects to the crankshaft 14. It is to be appreciated that the first and second end portions 26, 28 may connect to other components or other arrangements, and the FIGS. are for illustrative purposes only. Accordingly, the circumference of the second inner surface 52 (i.e., the second circumference) is greater than the circumference of the first inner surface 44 (i.e., the first circumference).

Referring to FIGS. 2, 6 and 9, the shank axis 20 intersects a center point 78A of the first cavity 46 and a center point 78B of the second cavity 54. The first bearing 40 may surround the center point 78A of the first cavity 46, and the second bearing 42 may surround the center point 78B of the second cavity 54. In the FIGS., the first and second bearings 40, 42 are schematically illustrated in phantom lines for illustrative purposes only. The first and second bearings 40, 42 may be any suitable configuration, and non-limiting examples may include journal bearings 40, 42, roller bearings 40, 42, ball bearings 40, 42, plain bearings 40, 42, etc. Therefore, for example, the first and second bearings 40, 42 may be defined as the first inner surface 44 and the second inner surface 52, i.e., no additional structure disposed in the first and second cavities 46, 54; and/or the first and second bearings 40, 42 may be defined as additional structure disposed in the first and second cavities 46, 54, e.g., ball bearings, etc.

In certain embodiments, the first bearing 40 and the second bearing 42 may each include an outer race, an inner race, and a plurality of rollers disposed between the outer race and the inner race of the respective first and second bearings 40, 42. Each of the first bearing 40 and the second bearing 42 may include a pair of metal shields on opposite sides of the rollers. If the first and second bearings 40, 42 are further defined as journal bearings 40, 42, the passage between the bearings 40, 42 may be filled with the fluid to provide the desired lubrication and/or cooling to the journal bearings.

With reference to FIGS. 7, 8, 10 and 11, the connecting rod 16 may include a plurality of layers 80. Each of the layers 80 may include the fibers 68. As such, the fibers 68 are stacked together. As shown in FIGS. 7 and 10, at the shank 18, for example, four layers 80 are stacked together. As shown in FIGS. 8 and 11, at the second end portion 28 of the connecting rod 16, for example, six layers 80 are stacked together. Six layers 80 may also be stacked together at the first end portion 26 of the connecting rod 16. Thus, each of the first end portion 26 and the second end portion 28 may include more layers 80 than the shank 18 to optimally resist stress experienced by the connecting rod 16. Overall, as a non-limiting example, the connecting rod 16 may include six layers 80, each including fibers 68, namely: a first layer 82, a second layer 84, a third layer 86, a fourth layer 88, a fifth layer 90 and a sixth layer 92 shown in FIGS. 8 and 11. The first layer 82 may be referred to as a first outermost layer 80, and the sixth layer 92 may be referred to as the second outermost layer 80, which is opposite the first outermost layer 80. The second layer 84, the third layer 86, the fourth layer 88 and the fifth layer 90 may be referred to herein as the intermediate layers 80. Although the depicted embodiment illustrates six layers 80, it is contemplated that the connecting rod 16 may include more or fewer layers 80.

FIGS. 8 and 11 are cross-sectional views traversing the second end portion 28, which would also traverse the second bearing 42. However, except for the dimension, the cross-section at the first bearing 40 and the first end portion 26 is identical to the cross-sectional view shown in FIGS. 8 and 11, and therefore, will not be duplicated. Optionally, the first layer 82 and the sixth layer 92 (i.e., the outermost layers) may overlap the second bearing 42 to lock the second bearing 42 in place. In particular, the first layer 82 (i.e., the first outermost layer) and the sixth layer 92 (i.e., the second outermost layer) may be closer to the inner race of the second bearing 42 (and the first bearing 40) than the intermediate layers 80 (i.e., the second layer 84, the third layer 86, the fourth layer 88 and the fifth layer 90), thereby overlapping the second bearing 42 (and the first bearing 40) to lock the second bearing 42 (and the first bearing 40) in place.

Optionally, the connecting rod 16 may further include over-braiding (or over-weaving) in selected areas to add additional support. The over-braiding strengthens the fibers 68. For example, the over-braiding may surround the shank 18 to support the shank fibers 70, thereby enhancing fatigue performance.

The present disclosure also provides a method of manufacturing the connecting rod 16. The method includes placing the plurality of fibers 68 in a predetermined arrangement, and adding the resin to the plurality of fibers 68 to connect the fibers 68 together and form the composite of at least the shank 18. Hence, for each of the configurations discussed herein, at a minimum, the shank 18 is formed of the composite. In other configurations, the shank 18, as well as the first and second end portions 26, 28, are each formed of the composite.

The method also includes disposing the component 32 inside the shank 18. As discussed above, the component 32 is utilized to define the channel 30 in the shank 18. Regardless of whether the connecting rod 16 is formed as a one-piece structure or multiple pieces, the component 32 is utilized to provide the channel 30 in the shank 18. Therefore, at a minimum, the fibers 68 and the resin are disposed around the component 32 before molding the shank 18.

If the connecting rod 16 is formed as the one-piece structure, then the component 32 may be disposed in the first end portion 26, the second end portion 28 and the shank 18. Therefore, in this configuration, the fibers 68 and the resin are disposed around the first end portion 26, the second end portion 28 and the shank 18 before molding the connecting rod 16. If the connecting rod 16 is formed as multiple separate pieces connected together, then the component 32 may be disposed in the shank 18. In this configuration, the fibers 68 and the resin are disposed around the component 32 before molding the shank 18. The component 32 may be removable (such as: ignited or burned, vaporized, melted, decomposed, dissolved, manually extracted from the channel 30) as discussed above, or may be the tube 34 that remains part of the final product.

Generally, the method also includes coupling the first end portion 26 to the shank 18, and coupling the second end portion 28 to the shank 18. The shank 18 and the first and second end portions 26, 28 may be coupled to each other in different ways.

For example, the first end portion 26 and the second end portion 28 may be separate pieces from the shank 18. In this configuration, coupling the first end portion 26 to the shank 18 further includes inserting a protrusion 94A of the first end portion 26 into a first recess 96 of the shank 18. Additionally, coupling the second end portion 28 to the shank 18 further includes inserting a protrusion 94B of the second end portion 28 into a second recess 98 of the shank 18.

It is to be appreciated, in this configuration, the first and second end portions 26, 28 may be formed of a different material from the shank 18, and then each of the pieces are coupled, and more specifically, secured together. Hence, the first and second end portions 26, 28 may be formed in a different process from the shank 18. The first and second end portions 26, 28 may be formed by various methods, and non-limiting examples include casting, forging, machining, powder sintered, or any other suitable process. Furthermore, for example, the first and second end portions 26, 28 may be formed of metal, in which case the first and second passageways 48, 56 may be machined, drilled, gun-drilled, etc., to form the first and second passageways 48, 56, and separately, the shank 18 may be formed of the composite. Therefore, when the protrusion 94A of the first end portion 26 is inserted into the first recess 96 of the shank 18, the first passageway 48 and the channel 30 align with each other where the first passageway 48 and the channel 30 meet to provide fluid communication therethrough. Additionally, when the protrusion 94B of the second end portion 28 is inserted into the second recess 98 of the shank 18, the second passageway 56 and the channel 30 align with each other where the second passageway 56 and the channel 30 meet to provide fluid communication therethrough.

When the first and second end portions 26, 28 are separate from the shank 18, these pieces may be secured together by various methods. Non-limiting examples of how the first and second end portions 26, 28 may be secured to the shank 18 include adhesive; mechanical locking features, such as one or more of bolts, pins, screws, threads, knurling, dovetails, clips; friction fit; interference fit; shrink fit; widening the metal portion for the first and second bearings 40, 42 will create a natural interlock in compression; and combinations thereof. For example, if utilizing the bolt or the pin, at least one bolt would be disposed through the protrusion 94A of the first end portion 26 and the shank 18 at that location, and another bolt would be disposed through the protrusion 94B of the second end portion 28 and the shank 18 at that location.

The shank 18 may be formed of the composite as discussed above, and via the method discussed further below. Referring to FIG. 3, the shank 18 may completely fill the area that is cross-sectioned in phantom lines (labeled as reference number 100) with the composite or a core. Hence, the shank 18 may be formed utilizing a preform, a mold or an overwrapping process.

The composite may be overwrapped on the core to form the shank 18. In this configuration, the first and second end portions 26, 28 are positioned relative to respective ends of the core, and then, the composite is overwrapped on the core (the composite is formed via the placement of the fibers 68 and adding the resin as discussed herein) and at least partially over the protrusion 94A of the first end portion 26 and the protrusion 94B of the second end portion 28. The composite may be overwrapped by various methods, and non-limiting examples may include filament winding, braiding, weaving or any other suitable process. In various configurations, the area labeled as reference number 100 may be hollow by removing the core after forming the composite outer shell (the outer shell labeled as reference number 102).

If the core is to be removed from the outer shell, a hole 104 may be defined through the outer shell to remove the core, and the core may be water soluble, meltable, burnable, etc., to remove the core from the shank 18. Non-limiting examples of the core may include foam, metal, etc. After the core is removed from the outer shell (if the core is removable), the hole 104 is plugged to prevent debris, fluids, etc., from entering the hollow shank 18. The core may be 3D printed, molded, casted or made of any other suitable methods.

Once the shank 18 has cured, if the component 32 is further defined as the sacrificial component, and the method may further include removing the sacrificial component from the shank 18, thereby forming the channel 30 in the shank 18. When the shank 18 is a separate piece from the first and second end portions 26, 28, the component 32 may be removed before or after coupling the first and second end portions 26, 28 to the shank 18. If the component 32 is further defined as the tube 34, the method may further include forming the composite of the shank 18 around the tube 34, and the tube 34 remains inside the shank 18 to define the channel 30 in the shank 18. In this configuration, the shank 18 is formed with the tube 34 before coupling the first and second end portions 26, 28 to the shank 18.

As another example, the first and second end portions 26, 28 may be formed of the same material as the shank 18, and the first and second end portions 26, 28 and the shank 18 are coupled together, and more specifically, secured together as the one-piece structure. In this configuration, for example, the shank 18, the first end portion 26 and the second end portion 28 are each formed together of the composite. More specifically, the shank 18, the first end portion 26 and the second end portion 28 are each formed together of the polymer composite. Therefore, in this configuration, the component 32 is utilized to define the channel 30, the first passageway 48 in the first end portion 26 and the second passageway 56 in the second end portion 28. In this configuration, coupling the first end portion 26 to the shank 18 further includes placing the fibers 68 and adding the resin to the fibers 68 to connect the fibers 68 together and form the shank 18, the first end portion 26 as the one-piece structure. Additionally, coupling the second end portion 28 to the shank 18 further comprises placing the fibers 68 and adding the resin to the fibers 68 to connect the fibers 68 together and form the shank 18, the second end portion 28 as the one-piece structure. Generally, coupling the first and second end portions 26, 28 to the shank 18 occurs at the same time due to the connecting rod 16 being formed as the one-piece structure. More specifically, in this configuration, the fibers 68 and the resin are disposed around the component 32 before molding the shank 18, the first end portion 26 and the second end portion 28. The component 32 may be removable (such as: ignited or burned, vaporized, melted, decomposed, dissolved, manually extracted from the channel 30) as discussed above, or may be the tube 34 that remains part of the final product.

Then, the resin is solidified by, for example, polymerization. The fibers 68 may be placed in the predetermined arrangement by using a tailored fiber placement (TFP) process. As such, the method may include placing the plurality of fibers 68 in the predetermined arrangement using the TFP process. The TFP process is used to create the fiber preform with the component 32 also disposed in the preform to form the desired channel 30, and the desired passageways 48, 56 if the first and second end portions 26, 28 are also formed of the composite. In addition, the TFP process is highly controllable, thereby minimizing fiber waste. During the TFP process, the fibers 68 are oriented inline with principal stresses to optimally resist stresses experienced by the connecting rod 16.

In the TFP process, if the first and second end portions 26, 28 are also formed of the composite with the shank 18, the fibers 68 are directly placed around the component 32, the first bearing 40 and the second bearing 42. Hence, the component 32 is embedded in the preform prior to resin infusion. It is contemplated that the first bearing 40 and the second bearing 42 may be integrated with an assembled crankshaft 14.

Further, the TFP process may include placing the fibers 68 around the first bearing 40 and around the second bearing 42 such that the fibers 68 completely surround the first bearing 40 and the second bearing 42. More specifically, the TFP process may include placing the fibers 68 (i.e., the first-end fibers 74) directly around the first bearing 40, and placing the fibers 68 (i.e., second-end fibers 76) directly around the second bearing 42. As such, the fibers 68 (i.e., the first-end fibers 74) completely surround the first bearing 40, and other fibers 68 (i.e., the second-end fibers 76) completely and continuously surround the second bearing 42. Next, the TFP process may include placing the fibers 68 (e.g., shank fibers 70) between the first bearing 40 and the second bearing 42. For example, at least some of the fibers 68 may be wrapped around the first bearings 40, then extend toward the second bearing 42, and finally wrapped around the second bearing 42. At least one of the fibers 68 is not wrapped around the first bearing 40 or the second bearing 42. Rather, this fiber (i.e., one of the shank fibers 70) is merely placed between the first bearing 40 and the second bearing 42. Each of the six layers 80 would be stitched together with a stitching yarn. The stitching yarn is smaller than the bundles of fiber (such as bundles of carbon fiber), and are just there to hold all of the fibers 68 in place.

The method may include forming a first half of the connecting rod 16 and forming a second half of the connecting rod 16 by placing the fibers 68 in the predetermined arrangement. Then, if the first and second end portions 26, 28 are also formed of the composite with the shank 18, the first bearing 40 and the second bearing 42 are sandwiched with the first half of the connecting rod 16 and the second half of the connecting rod 16 to assemble the connecting rod 16. Then, the resin is infused to the first half of the connecting rod 16 and the second half of the connecting rod 16. The component 32 is disposed in the preform before infusing the resin.

The method may entail using a 3D printer to place the plurality of fibers 68 in a predetermined arrangement, and to add the resin to the plurality of fibers 68 to connect the fibers 68 together to thereby form the connecting rod 16. In other words, placing the fibers 68 in the predetermined arrangement and adding the resin are performed in a single step using a 3D printing process. By employing this 3D printing process, no resin infusion is required to form the connecting rod 16.

In the method, placing the plurality of fibers 68 in the predetermined arrangement may entail wrapping fibers 68 around a first mandrel and a second mandrel to allow high-speed manufacturing of the connecting rod 16. In other words, placing the fibers 68 in the predetermined arrangement may include wrapping fibers 68 around two mandrels (i.e., the first mandrel and the second mandrel). The location and size of the first mandrel corresponds to the location of the first bearing 40 of the connecting rod 16, and the location and size of the second mandrel corresponds to the location and size of the second bearing 42. Accordingly, the second mandrel is larger than the first mandrel in order to manufacture the connecting rod 16 capable of being connected to the pistons 12 and the crankshaft 14 as described above.

After manufacturing the connecting rod 16 as set forth in the method, the second end portion 28 may be cut to be divided in half. Accordingly, the second end portion 28 is divided into two pieces, namely the first part and the second part. Then, the bearing and the crankshaft 14 is inserted in the second cavity 54 of the second end portion 28. In this method, a journal bearing may be used instead of a roller bearing. Accordingly, the connecting rod 16 may include a journal bearing coupled to the first end portion 26 and/or the second end portion 28. Next, a cap is coupled to the first part and the second part to assemble the second end portion 28 with the second bearing 42. The cap may be wholly or partly made of a metallic or composite material. The cap may be mechanically fastened or bonded to the second end portion 28 of the connecting rod 16. Although a split version of the connecting rod 16 is discussed above, it is contemplated the presently disclosed connecting rod 16 may also be a non-split version.

With regard to the split version of the connecting rod 16, the TFP process may be used to enable a split bearing design with one or more fastener. An example of a split bearing design is shown in FIGS. 2 and 3, which may also apply to FIGS. 6 and 9. The fastener extends through a flange of the connecting rod 16. The fibers 68 may follow the complex curves of the connecting rod 16 (e.g., the complex curves of the second end portion 28). The connecting rod 16 may be manufactured with weak zones wherein the fibers 68 come together (i.e., at the split). Then, the second end portion 28 is cut or etched in a scratch or groove. Next, stress is applied to crack the two halves of the second end portion 28 apart guided by the scratch/weak zone. At this point, the two halves of the second end portion 28 may be easily separated, and the metallic bearing surfaces 44, 52 may now be applied. As non-limiting examples, the fasteners could be dowels, bolts, sleeves, etc. and could be embedded between the first part and the second part of the second end portion 28.

Optionally, the method may entail filling the bearing (i.e., the first bearing 40 and/or second bearing 42) with a removable material. Specifically, the cage (which supports the rollers) may be filled with the removable material. The removable material may be referred to as a sacrificial material, which may be made of and removed in the ways discussed above for the sacrificial component. As additional non-limiting examples, the sacrificial material may further include polymers, waxes, and metals that melt and/or vaporize at a lower temperature than the resin of the matrix 66.

If the first and second end portions 26, 28 are also formed of the composite with the shank 18, the bearings 40, 42 (i.e., the first bearing 40 and/or second bearing 42) may each include a fin protruding from the cage. The fin is configured to support the fibers 68. After filling the bearings 40, 42 (i.e., the first bearing 40 and/or second bearing 42) with the removable material, the fibers 68 are placed along the bearing to form the preform. Specifically, the fibers 68 are placed along the fin. Once the preform is formed with the bearings 40, 42, the component 32 and the fibers 68 assembled together, the preform is placed in a mold cavity of the mold. Then, the resin is infused into the mold using a resin transfer molding process. The resin transfer molding process includes transferring the resin into the mold cavity of the mold to form a part. Next, the resin is cured to couple the fibers 68 to the bearings 40, 42 and the component 32. After curing, the part is removed from the mold. Next, the removable material is removed from the bearing, and the method further includes removing the removable material from the bearing (i.e., the first bearing 40 and/or second bearing 42) to form the connecting rod 16. As discussed above, the removable material may be removed from the bearing by melting, vaporizing, degrading, depolymerizing, and/or dissolving the removable material. Also, after the resin cures, if the component 32 is the sacrificial component, then the sacrificial component is removed from the connecting rod 16. Alternatively, after the resin cures, if the component 32 is the tube 34, then the component 32 remains in the connecting rod 16, and is not removed.

Alternatively, the first bearing 40 and/or the second bearing 42 may be a sealed bearing. As such, the method may entail using the sealed bearing (i.e., the first bearing 40 and/or second bearing 42), instead of filling the bearing(s) 40, 42 with the removable material. As such, sealed bearing cannot be filled with the removable material. In this method, the fibers 68 are placed along the bearing and the component 32 to form the preform. Specifically, the fibers 68 are placed along the fin. Once the preform is formed, the preform is placed in the mold cavity of the mold. Then, the resin is infused into the mold using a resin transfer molding process. The resin transfer molding process includes transferring the resin into the mold cavity of the mold to form a part. Next, the resin is cured to couple the fibers 68 to the bearing and the component 32. After curing, the part is removed from the mold. Also, after the resin cures, if the component 32 is the sacrificial component, then the sacrificial component is removed from the connecting rod 16. Alternatively, after the resin cures, if the component 32 is the tube 34, then the component 32 remains in the connecting rod 16, and is not removed.

The method of manufacturing the connecting rod 16 may include placing the component 32 between the two halves along the shank 18 and/or the first and second end portions 26, 28. The component 32 may be completely or partially surrounded by the fibers 68. The resin is then added and cured to form the composite. After the resin cures, if the component 32 is the sacrificial component, then the sacrificial component is removed from the connecting rod 16. Alternatively, after the resin cures, if the component 32 is the tube 34, then the component 32 remains in the connecting rod 16, and is not removed.

Once, the first and second end portions 26, 28 and the shank 18 are formed of the composite, then the component 32 may be removed if the component 32 is not the tube 34. If the component 32 is further defined as the sacrificial component, and the method may further include removing the sacrificial component from the shank 18, the first end portion 26 and the second end portion 28 thereby forming the channel 30 in the shank 18, the first passageway 48 in the first end portion 26 and the second passageway 56 in the second end portion 28. Furthermore, if the component 32 is further defined as the tube 34, the method may further include forming the composite of the shank 18, the first end portion 26 and the second end portion 28 around the tube 34, and the tube 34 remains inside the shank 18 to define the channel 30 in the shank 18, remains inside the first end portion 26 to define the first passageway 48 and remains inside the second end portion 28 to define the second passageway 56. Additionally, regarding the configurations of FIGS. 6 and 9, the inlet 60 and the outlet 62 may be drilled, machined, etc., to provide fluid communication between the first and second passageways 48, 56 and the first and second cavities 46, 54.

It is to be appreciated that the order or sequence of performing the method discussed and illustrated herein is for illustrative purposes and other orders, steps or sequences are within the scope of the present teachings, some of which have been discussed above.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration may be combined with one or a plurality of other desired characteristics from other configurations, resulting in other configurations not described in words or by reference to the drawings. Accordingly, such other configurations fall within the framework of the scope of the appended claims.

What is claimed is:

1. A connecting rod comprising:
a shank formed of a composite;
a first end portion coupled to the shank, wherein the first end portion has an annular shaped portion;
a second end portion coupled to the shank, wherein the second end portion has an annular shaped portion; and
wherein the shank defines a channel coupled to the first and second end portions.

2. The connecting rod as set forth in claim 1 further including a component disposed in the shank to form the channel.

3. The connecting rod as set forth in claim 2 wherein the component is further defined as a sacrificial component, wherein the sacrificial component is ignited to cause deflagration of the sacrificial component, thereby forming the channel in the shank.

4. The connecting rod as set forth in claim 2 wherein the component is further defined as a sacrificial component, wherein the sacrificial component is melted to remove the sacrificial component from the shank, thereby forming the channel in the shank.

5. The connecting rod as set forth in claim 2 wherein the component is further defined as a tube.

6. The connecting rod as set forth in claim 1 wherein:
the first end portion includes a first inner surface that defines a boundary of a first cavity;
the first end portion includes a first wall that defines a boundary of a first passageway, and the first passageway connects with the first cavity and the channel;
the second end portion includes a second inner surface that defines a boundary of a second cavity;
the second end portion includes a second wall that defines a boundary of a second passageway, and the second passageway connects with the second cavity and the channel; and
at least one of the first and second walls includes a tapered portion that changes a size of at least one of the first and second passageways respectively.

7. The connecting rod as set forth in claim 6 wherein:
the component is further defined as a tube, and the tube is disposed in the first and second end portions and the shank;
the tube includes a first end and a second end, with the first end of the tube is disposed in the first end portion and the second end of the tube is disposed in the second end portion; and
at least one of the first and second ends of the tube taper along the tapered portion of the at least one of the first and second walls respectively.

8. The connecting rod as set forth in claim 1 further including a first bearing secured to the first end portion and a second bearing secured to the second end portion.

9. The connecting rod as set forth in claim 8 wherein:
the first end portion defines a first passageway that opens to the first bearing;
the second end portion defines a second passageway that opens to the second bearing; and
the first and second passageways and the channel of the shank cooperate with each other to define a passage to the first and second bearings.

10. The connecting rod as set forth in claim 1 wherein the first end portion and the second end portion are each formed of a metal, wherein the composite is further defined as a polymer composite that is different from the metal of the first and second end portions.

11. The connecting rod as set forth in claim 1 wherein the shank extends along a shank axis, and the composite of the shank is further defined as a fiber-reinforced composite that includes a matrix and a plurality of fibers embedded in the matrix; wherein the plurality of fibers includes shank fibers disposed in the shank; and wherein at least one of the shank fibers is elongated along the shank axis.

12. The connecting rod as set forth in claim 1 wherein the shank, the first end portion and the second end portion are each formed of the composite.

13. The connecting rod as set forth in claim 12 wherein the shank extends along a shank axis, and the composite of the shank is further defined as a fiber-reinforced composite that includes a matrix and a plurality of fibers embedded in the matrix; wherein the plurality of fibers includes shank fibers disposed in the shank; and wherein at least one of the shank fibers is elongated along the shank axis.

14. The connecting rod as set forth in claim 13:
wherein the at least one of the shank fibers is oriented at a shank fiber angle relative to the shank axis;
wherein the shank fiber angle is between zero degrees and twenty-five degrees;
wherein the plurality of fibers includes first-end fibers, and the first-end fibers extend annularly within the first end portion;
wherein the first end portion includes a first inner surface that defines a boundary of a first cavity, and the first inner surface has an annular shape;
wherein the first inner surface has a first circumference, and at least one of the first-end fibers entirely and continuously surrounds an entirety of the first circumference of the first inner surface; and
further including a first bearing disposed in the first cavity.

15. The connecting rod as set forth in claim 14:
wherein the plurality of fibers includes second-end fibers, and the second-end fibers extend annularly within the second end portion;
wherein the second end portion includes a second inner surface that defines a boundary of a second cavity, and the second inner surface has an annular shape;
wherein the second inner surface has a second circumference, and at least one of the second-end fibers entirely and continuously surrounds an entirety of the second circumference of the second inner surface;
wherein the second circumference is greater than the first circumference; and
further including a second bearing disposed in the second cavity.

16. A method of manufacturing a connecting rod, comprising:
placing a plurality of fibers in a predetermined arrangement;
adding a resin to the plurality of fibers to connect the fibers together and form a composite of at least a shank;
disposing a component inside the shank, and the component is utilized to define a channel in the shank;
coupling a first end portion to the shank; and
coupling a second end portion to the shank.

17. The method as set forth in claim 16 wherein:
the first end portion and the second end portion are separate pieces from the shank;
coupling the first end portion to the shank further comprises inserting a protrusion of the first end portion into a first recess of the shank; and
coupling the second end portion to the shank further comprises inserting a protrusion of the second end portion into a second recess of the shank.

18. The method as set forth in claim 16 wherein:
the shank, the first end portion and the second end portion are each formed together of the composite;
coupling the first end portion to the shank further comprises placing the fibers and adding the resin to the fibers to connect the fibers together and form the shank, the first end portion as a one-piece structure; and
coupling the second end portion to the shank further comprises placing the fibers and adding the resin to the fibers to connect the fibers together and form the shank, the second end portion as a one-piece structure.

19. The method as set forth in claim 16 wherein the component is further defined as a sacrificial component, and further comprising removing the sacrificial component from the shank, thereby forming the channel in the shank.

20. The method as set forth in claim 16:
wherein the component is further defined as a tube; and
further comprising forming the composite of the shank around the tube, and the tube remains inside the shank to define the channel in the shank.
